(19) United States
(12) Patent Application Publication
(10) Pub. No.: US 2023/0368807 A1
(43) Pub. Date: Nov. 16, 2023

(54) DEEP-LEARNING BASED SPEECH ENHANCEMENT

(71) Applicant: Dolby Laboratories Licensing Corporation, San Francisco, CA (US)

(72) Inventors: Xiaoyu LIU, Dublin, CA (US); Michael Getty HORGAN, Brewster, MA (US); Roy M. FEJGIN, San Francisco, CA (US); Paul HOLMBERG, North Ryde (AU)

(73) Assignee: Dolby Laboratories Licensing Corporation, San Francisco, CA (US)

(21) Appl. No.: 18/250,393

(22) PCT Filed: Oct. 29, 2021
(86) PCT No.: PCT/US2021/057378

§ 371 Date: Apr. 25, 2023

Related U.S. Application Data
(60) Provisional application No. 63/115,213, filed on Nov. 18, 2020.
(60) Provisional application No. 63/221,629, filed on Jul. 14, 2021.

(30) Foreign Application Priority Data
Oct. 29, 2020 (WO) PCT/CN2020/124635

(51) Int. Cl. G10L 21/0232; G10L 19/022

(52) U.S. Cl. CPC G10L 21/0232; G10L 19/022

(57) ABSTRACT

A system for suppressing noise and enhancing speech and a related method are disclosed. The system trains a neural network model that takes banded energies corresponding to an original noisy waveform and produces a speech value indicating the amount of speech present in each band at each frame. The neural model comprises a feature extraction block that implements some lookahead. The feature extraction block is followed by an encoder with steady down-sampling along the frequency domain forming a contracting path. The encoder is followed by a corresponding decoder with steady up-sampling along the frequency domain forming an expanding path. The decoder receives scaled output feature maps from the encoder at a corresponding level. The decoder is followed by a classification block that generates a speech value indicating an amount of speech present for each frequency band of the plurality of frequency bands at each frame of the plurality of frames.

### CROSS REFERENCE TO RELATED APPLICATIONS

This application claims priority to U.S. Provisional Application No. 63/115,213, filed Nov. 18, 2020, U.S. Provisional Application No. 63/221,629 filed Jul. 14, 2021, and International Patent Application No. PCT/CN2020/124635, filed Oct. 29, 2020, all of which are incorporated herein by reference in their entirety.

### TECHNICAL FIELD

The present Application relates to noise reduction from speech. More specifically, example embodiment(s) described below relate to applying deep-learning models to produce frame-based inference from large speech context.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

It is generally difficult to accurately remove noise from a mixture signal of speech and noise, considering the different forms of speech and different types of noise that are possible. It can be especially challenging to suppress noise in real time.

### SUMMARY

A system for suppressing noise and enhancing speech and a related method are disclosed. The method comprises receiving, by a processor, input audio data covering a plurality of frequency bands along a frequency dimension at a plurality of frames along a time dimension; training, by the processor, a neural network model, the neural network model comprising: a feature extraction block that implements a lookahead of a specific number of frames in extracting features from the input audio data; an encoder that includes a first series of blocks producing first feature maps corresponding to increasingly larger receptive fields in the input audio data along the frequency dimension a decoder that includes a second series of blocks receiving output feature maps generated by the encoder as input feature maps and producing second feature maps; and a classification block that receives the second feature maps and generates a speech value indicating an amount of speech present for each frequency band of the plurality of frequency bands at each frame of the plurality of frames; receiving new audio data comprising one or more frames; executing the neural network model on the new audio data to generate new speech values for each frequency band of the plurality of frequency bands at each frame of the one or more frames; generating new output data suppressing noise in the new audio data based on the new speech values; transmitting the new output data.

### BRIEF DESCRIPTION OF THE DRAWINGS

The example embodiment(s) of the present invention are illustrated by way of example, and not in way by limitation, in the figures of the accompanying drawings and in which like reference numerals refer to similar elements and in which:

FIG. 1 illustrates an example networked computer system in which various embodiments may be practiced.

FIG. 2 illustrates example components of an audio management server computer in accordance with the disclosed embodiments.

FIG. 3 illustrates an example neural network model for noise reduction.

FIG. 4A illustrates an example feature extraction block.

FIG. 4B illustrates another example feature extraction block.

FIG. 5 illustrates an example neural network model as a component of the neural model illustrated in FIG. 3.

FIG. 6 illustrates an example neural network model as a component of the neural network model illustrated in FIG. 5.

FIG. 7 illustrates an example neural network model, as a component of the neural model illustrated in FIG. 3.

FIG. 8 illustrates an example process performed with an audio management server computer in accordance with some embodiments described herein.

FIG. 9 is a block diagram that illustrates a computer system upon which an embodiment of the invention may be implemented.

### DESCRIPTION OF THE EXAMPLE EMBODIMENTS

In the following description, for the purposes of explanation, numerous specific details are set forth in order to provide a thorough understanding of the example embodiment(s) the present invention. It will be apparent, however, that the example embodiment(s) may be practiced without these specific details. In other instances, well-known structures and devices are shown in block diagram form in order to avoid unnecessarily obscuring the example embodiment(s).

Embodiments are described in sections below according to the following outline:
1. GENERAL OVERVIEW
2. EXAMPLE COMPUTING ENVIRONMENTS
3. EXAMPLE COMPUTER COMPONENTS
4. FUNCTIONAL DESCRIPTIONS
   4.1. NEURAL NETWORK MODEL
      4.1.1. FEATURE EXTRACTION BLOCK
      4.1.2. U-NET BLOCK
         4.1.2.1. DENSE BLOCK
         4.1.2.1.1. DEPTH-WISE SEPARABLE CONVOLUTION WITH GATING
         4.1.2.2. RESIDUAL BLOCK AND RECURRENT LAYER
   4.2. MODEL TRAINING
   4.3. MODEL EXECUTION
5. EXAMPLE PROCESSES
6. HARDWARE IMPLEMENTATION

### 1. General Overview

A system for suppressing noise and enhancing speech and a related method are disclosed. In some embodiments, the system trains a neural network model that takes banded energies corresponding to an original noisy waveform and produces a speech value indicating the amount of speech present in each band at each frame. These speech values can be used to suppress noise by reducing the frequency magnitudes in those frequency bands where speech is less likely to be present. The neural network model has low latency and can be used for real-time noise suppression. The neural model comprises a feature extraction block that implements some lookahead. The feature extraction block is followed by an encoder with steady down-sampling along the frequency domain forming a contracting path. The convolution along the contracting path is performed with increasingly larger dilation factors along the time dimension. The encoder is followed by a corresponding decoder with steady up-sampling along the frequency domain forming an expanding path. The decoder receives scaled output feature maps from the encoder at a corresponding level so that features extracted from different receptive fields along the frequency dimension can all be considered in determining how much speech is present in each frequency band at each frame.

In some embodiments, at run time, the system takes a noisy waveform, converts it into the frequency domain covering a plurality of perceptually motivating frequency bands at each frame. The system then executes the model to obtain the speech value for each frequency band at each frame. Subsequently, the system applies the speech values to the original data in the frequency domain and transforms it back to an enhanced, noise-suppressed waveform.

The system has various technical benefits. The system is designed to be accurate while low latency for real-time noise suppression. The low latency is achieved via a relatively small number of relatively small convolution kernels, such as eight two-dimensional kernels of size 1 by 1 or 3 by 3, in a lean convolutional neural network (CNN) model. The consolidation of initial frequency domain data into perceptually motivating bands further reduces the amount of computation. Depth-wise separable convolution that tends to reduce execution time is also applied where possible.

The accuracy is achieved via feature extraction against different receptive fields in the input data along the frequency dimension, which are used in combination to achieve dense classification. A specific feature extraction block that incorporates a lookahead of a small number of frames, such as one or two frames, further contributes to the richness of the features. Dense blocks where output feature maps of a convolutional layer are propagated to all subsequent convolutional layer are also applied where possible. In addition, the neural model can be trained to predict not only the amount of speech present for each frequency band at each frame, but the distribution of such amounts. Addition parameters of the distribution can be used to fine tune the predictions.

### 2. Example Computing Environments

FIG. 1 illustrates an example networked computer system in which various embodiments may be practiced. FIG. 1 is shown in simplified, schematic format for purposes of illustrating a clear example and other embodiments may include more, fewer, or different elements.

In some embodiments, the networked computer system comprises an audio management server computer 102 (“server”), one or more sensors 104 or input devices, and one or more output devices 110, which are communicatively coupled through direct physical connections or via one or more networks 118.

In some embodiments, the server 102 broadly represents one or more computers, virtual computing instances, and/or instances of an application that is programmed or configured with data structures and/or database records that are arranged to host or execute functions related to low-latency speech enhancement by noise reduction. The server 102 can comprise a server farm, a cloud computing platform, a parallel computer, or any other computing facility with sufficient computing power in data processing, data storage, and network communication for the above-described functions.

In some embodiments, each of the one or more sensors 104 can include a microphone or another digital recording device that converts sounds into electric signals. Each sensor is configured to transmit detected audio data to the server 102. Each sensor may include a processor or may be integrated into a typical client device, such as a desktop computer, laptop computer, tablet computer, smartphone, or wearable device.

In some embodiments, each of the one or more output devices 110 can include a speaker or another digital playing device that converts electrical signals back to sounds. Each output device is programmed to play audio data received from the server 102. Similar to a sensor, an output device may include a processor or may be integrated into a typical client device, such as a desktop computer, laptop computer, tablet computer, smartphone, or wearable device.

The one or more networks 118 may be implemented by any medium or mechanism that provides for the exchange of data between the various elements of FIG. 1. Examples of the networks 118 include, without limitation, one or more of a cellular network, communicatively coupled with a data connection to the computing devices over a cellular antenna, a near-field communication (NFC) network, a Local Area Network (LAN), a Wide Area Network (WAN), the Internet, a terrestrial or satellite link, etc.

In some embodiments, the server 102 is programmed to receive input audio data corresponding to sounds in a given environment from the one or more sensors 104. The sever 102 is programmed to next process the input audio data, which typically corresponds to a mixture of speech and noise, to estimate how much speech is present in each frame of the input data. The server 102 is also programed to update the input audio data based on the estimates to produce cleaned-up output audio data expected to contain less noise than the input audio data. Furthermore, the server 102 is programmed to send the output audio data to the one or more output devices.

### 3. Example Computer Components

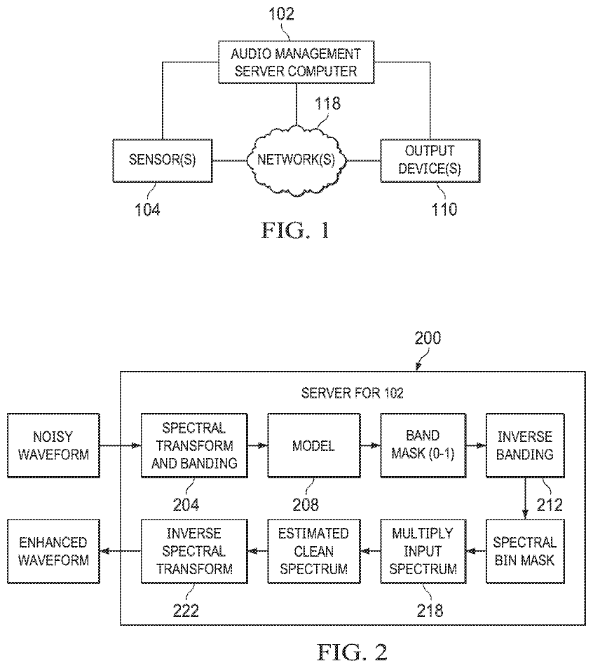

FIG. 2 illustrates example components of an audio management server computer in accordance with the disclosed embodiments. The figure is for illustration purposes only and the server 102 can comprise fewer or more functional or storage components. Each of the functional components can be implemented as software components, general or specific-purpose hardware components, firmware components, or any combination thereof. Each of the functional components can also be coupled with one or more storage components (not shown). A storage component can be implemented using any of relational databases, object databases, flat file systems, or JSON stores. A storage component can be connected to the functional components locally or through the networks using programmatic calls, remote procedure call (RPC) facilities or a messaging bus. A component may or may not be self-contained. Depending upon implementation-specific or other considerations, the components may be centralized or distributed functionally or physically.

In some embodiments, the server 102 comprises a spectral transform and branding block 204, a model block 208, an inverse banding block 212, a multiplication of input spectrum block 218, and an inverse spectral transform block 222.

In some embodiments, the server 102 receives a noisy waveform. In the block 204, the server 102 segments the waveform into a sequence of frames through a spectral transform, such as a sequence that is six seconds long having 20-ms frames (resulting 300 frames) with or without overlapping. The spectral transform may be any of a variety of transforms, such as the Short-Time Fourier Transform or Complex Quadrature Mirror Filterbank (CQMF) transform, the latter of which tends to yield minimal aliasing artifacts. To ensure a relatively high frequency resolution, the number of transform kernels/filters per 20-ms frame can be chosen such that the frequency bin width is approximately 25 Hz.

In some embodiments, the server 102 then converts the sequence of frames into a vector of banded energies, for 56 perceptually motivated bands, for example. Each perceptually motivated band is typically located in a frequency domain, such as from 120 Hz to 2,000 Hz, that matches how a human ear processes speech, such that capturing data in these perceptually motivated band means not losing speech quality to a human ear. More specifically, the squared magnitudes of the output frequency bins of the spectral transform are grouped into perceptually motivated bands, where the number of frequency bins per band increases at higher frequencies. The grouping strategy may be “soft” with some spectral energy being leaked across neighboring bands or “hard” with no leakage across bands.

In some embodiments, when the bin energies of a noisy frame are represented by x being a column vector of size p by 1, where p denotes the number of bins, the conversion to a vector of banded energies could be performed by computing y=W*x, where y is a column vector of size q by 1 representing the band energies for this noisy frame, W is a banding matrix of size q by p, and q denotes the number of perceptually motivated bands.

In some embodiments, in the block 208, the server 102 predicts a mask value for each band at each frame that indicates the amount of speech present. In the block 212, the server 102 converts the band mask values back to the spectral bin masks.

In some embodiments, when the band masks for y is represented by a column vector m_band of size q by 1, the conversion to the bin masks can be performed by computing m_bin=W_transpose*m_band, where m_bin is a column vector of size p by 1, and W_transpose of size ofp by q is the transpose of W. In the block 218, the server 102 multiplies the spectral magnitude masks with the spectrum magnitudes to effect the masking or reduction of noise and obtain an estimated clean spectrum. Finally, in the block 222, the server converts the estimated clean spectral spectrum back to a waveform as an enhanced waveform (over the noise waveform), which could be communicated via an output device, using any method known to someone skilled in the art, such as an inverse transform (such as inverse CQMF).

### 4. Functional Descriptions

### 4.1. Neural Network Model

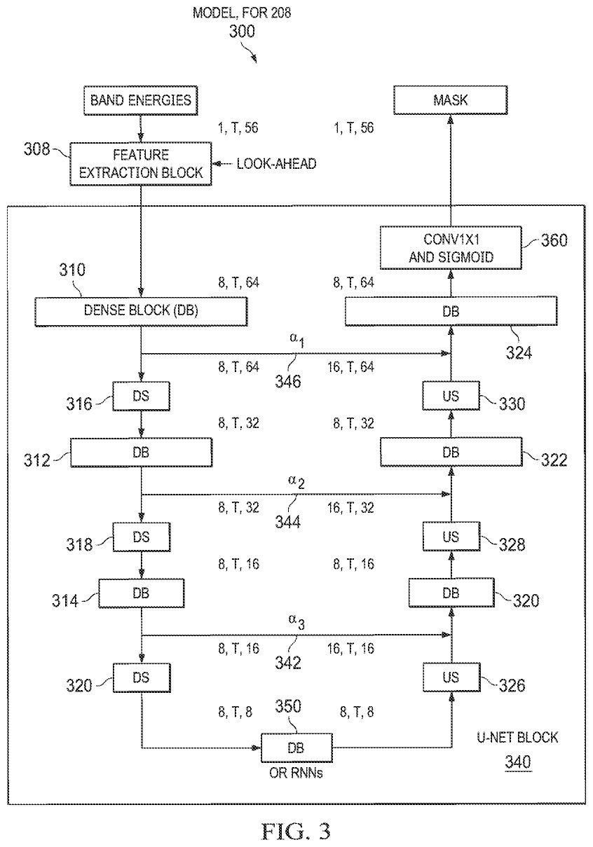

FIG. 3 illustrates an example neural network model 300 for noise reduction, which represents an embodiment of the block 208. In some embodiments, the model 300 comprises a block 308 for feature extraction, and a block 340 that is based on a U-Net structure, such as the one described in arXiv:1505.04597v1 [cs.CV] 18 May 2015, but has several variations, as described herein. The U-Net structure has been shown to enable precise of localization of feature recognition and classification.

### 4.1.1. Feature Extraction Block

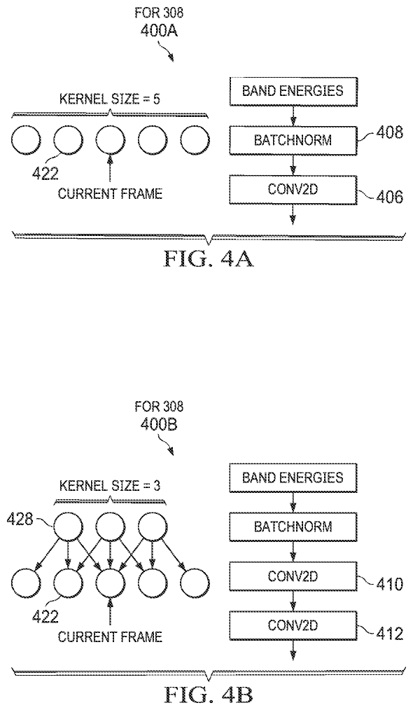

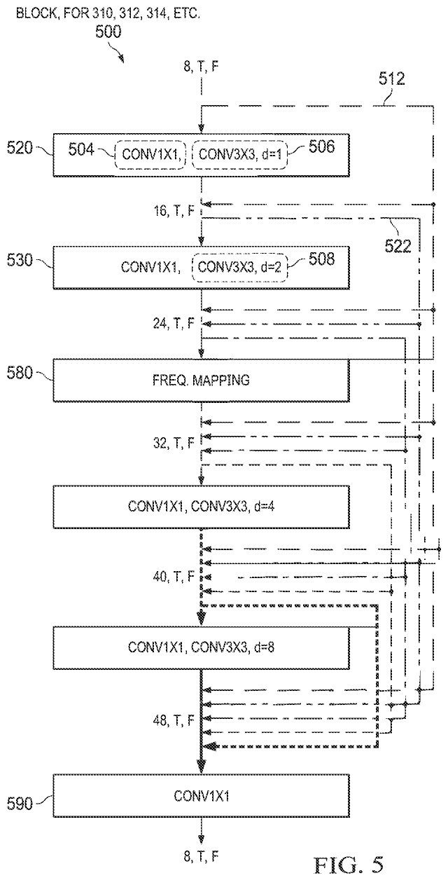

In some embodiments, in the block 308 in FIG. 3, the server 102 extracts high-level features optimized for the noise suppression task from the raw band energies. FIG. 4A illustrates an example feature extraction block, which represents an embodiment of the block 308. FIG. 4B illustrates another example feature extraction block. As illustrated in the structure 400A in FIG. 4A, for example, the server 102 can normalize the mean and variance of the band energies (e.g., 56 of them) in a sequence of T frames by a learnable batch normalization layer 408 known to someone skill in the art. Alternatively, global normalization can also pre-computed from the training set using a technique known to someone skilled in the art.

In some embodiments, the server 102 can take into consideration future information in extracting the above-mentioned high-level features. As illustrated in 400A in FIG. 4A, for example, such lookahead can be implemented with a two-dimensional (2D), one channel convolutional layer (conv2d) layer 406 with one or more kernels. The height of a kernel in the conv2d layer 406 corresponding to the number of bands to evaluate each time could be set to a small value, such as three. The kernel size along the time axis depends on how much lookahead is desired or allowed. For example, with no lookahead, the kernel can cover the current frame and the past L frames, such as two frames, and when L future frames are allowed, the kernel size can be 2L+1 centered at the current frame, to be matched with 2L+1 frames in the input data each time, such as 422 with L being two in 406. As illustrated in 400B in FIG. 4B, the lookahead can also be implemented with a series of conv2d layers 410, 412, or more. Each kernel has a small kernel size along the time axis then. For example, the L could be set to one for 410, 412, and every other similar layer. As a result, the layer 410 could be matched with the original input data with 2L+1 lookahead, such as 422 with L being one leading to the three kernels 428, and the layer 412 could be matched with the output of the layer 412. The server can use the series of conv2d layers illustrated in FIG. 4B to gradually increase the receptive field within the input data.

In some embodiments, the number of kernels in each conv2d layers can be determined based on the nature of the input audio stream, the volume of desired high-level features, the scope of computing resource requirements, or another factor. For example, the number could be 8, 16, or 32. In addition, each of the conv2d layers in the block 308 can be followed by a nonlinear activation function, such as a parametric rectified linear unit (PReLU), which can then be followed by a separate batch normalization layer, to finetune the output of the block 308.

In some embodiments, the block 308 can be implemented using other signal processing techniques unrelated to artificial neural networks, such as the one described in C. Kim and R. M. Stern, “Power-Normalized Cepstral Coefficients (PNCC) for Robust Speech Recognition,” in IEEE/ACM Transactions on Audio, Speech, and Language Processing, vol. 24, no. 7, pp. 1315-1329, July 2016, doi: 10.1109/TASLP.2016.2545928.

### 4.1.2. U-Net Block

In some embodiments, in the block 340 in FIG. 3, the server 102 performs encoding of the feature data (to find more, better features) followed by decoding to reconstruct enhanced audio data before finally performing classification to determine how much speech is present. The block 340 thus comprises an encoder side on the left, and a decoder on the right, connected by a block 350. The encoder comprises one or more feature computation blocks, such as 310, 312, and 314, each followed by a frequency down-sampler, such as 316, 318, and 320, to form a contracting path. A dense block (DB) is one implementation for such a feature computation block, as further discussed below. Each of the triples indicated in the diagram, such as (8, T, 64), includes the size of the input or output data of a feature computational block, where the first component denotes the number of channels or feature maps, the second component denotes a fixed number of frames along the time dimension, and the third component denotes a size along the frequency dimension. These feature computation blocks, as further discussed below, capture higher and higher-level features in larger and larger frequency contexts. The block 350 comprises a feature computation block to perform modeling that covers all perceptually motivated bands originally available. The decoder also comprises one or more feature computation blocks, such as 320, 322, and 324, each followed by a frequency up-sampler, such as 326, 328, and 330, to form an expanding path. These feature computation blocks in the expanding path, which rely on the feature maps generated during the contracting path, combine to project discriminative features at different levels onto a high-resolution space, namely at the per-band level at each frame, to get a dense classification, namely the mask values. Due to the combination, the number of input channels (or feature maps) for each feature computation block in the expanding path can be twice as many as that for each feature computational block in the contracting path. However, the choice in the number of kernels in each computation block could determine the number of output channels, which become the number of input channels for the next feature computational block in the expanding path.

The server 102 produces the final mask values for each band at a frame through a classification block, such as the block 360, comprising a 1×1 2D kernel followed by the sigmoid nonlinear activation function.

In some embodiments, in each frequency down-sampler, the server 102 merges each two adjacent band energies by a conv2d layer with kernel and stride sizes of 2 along the frequency axis via a regular convolution or a depth-wise convolution. Alternatively, the conv2d layer can be replaced by a max-pooling layer. In either case, the width of the output feature maps halves after each frequency down-sampler, thereby steadily enlarging the receptive field within the input data. To enable such sequential, exponential reduction in the width of the output feature maps, the server 102 pads the output of the block 308 to a width that is a power of 2, which then becomes the input data to the block 340. The padding could be done, for example, by adding zeros on both sizes of the output feature maps of the block 308.

In some embodiments, in each frequency up-sampler, the server 102 employs a transpose conv2d layer corresponding to the conv2d layer at the same level in the encoder to restore the original number of band energies. The depth of the block 340, or the number of combinations of a feature computation block and a frequency down-sampler (and equivalently the number of combinations of a feature computation block and a frequency up-sampler), could depend on the desired maximum receptive field, the amount of computing resources, or other factors.

In some embodiments, the server 102 uses skip connections, such as 342, 344, and 346, to concatenate the output of a feature computation block in the encoder with the input of a feature computation block in the decoder at the same level as a way for the decoder to receive discriminative features of the input data at different levels ultimately for a dense classification, as noted above. For example, the feature maps produced by the block 310 are used together as input data with the feature maps fed into the block 324 from the frequency up-sampler 330 via the skip connection 346. As a result, the number of channels in the input data of each feature computation block in the decoder would be twice as large as the number of channels in the input data of each dense block in the encoder.

In some embodiments, instead of a straightforward concatenation, the server 102 learns a scaler multiplier for each skip connection, such as α₁, α₂, and α₃, as shown in FIG. 3. Each αᵢ contains N (e.g., 8) learnable parameters, which could be initialized to 1 at the beginning of training. Each of the learnable parameters is used to multiply a feature map generated by the corresponding feature computation block in the encoder to produce a scaled feature map, which is then concatenated with the feature map to be fed into the corresponding feature computation block in the decoder.

In some embodiments, the server 102 can replace concatenation with adding. For example, the eight feature maps produced by the block 310 can be added respectively to the 8 feature maps to be fed into the dense block 324, with each of the eight additions being performed on component-basis. Such addition instead of concatenation reduces the number of feature maps used as input data to each feature computation block in the decoder and overall reduces computation at the cost of certain performance degradation.

### 4.1.2.1. Dense Block

FIG. 5 illustrates an example neural network model, which corresponds to an embodiment of the block 310 and every other similar block in the block 340 in FIG. 3. The neural network model is based on a DenseNet structure, such as the one described in arXiv:1608.06993v5 [cs.CV] 28 Jan. 2018, but has several variations, as described herein. The DenseNet structure has been shown to alleviate the vanishing-gradient problem, strengthen feature propagation, encourage feature reuse, and reduce the number of parameters.

In some embodiments, the server 102 uses the block 500 as a feature computation block to further strengthen feature propagation and dense classification. The block 500 outputs N (e.g., 8) channels of feature maps the same as the number of feature maps input data. Each channel also each has the same time-frequency shape as a feature map in the input data. The block 500 comprises a series of convolutional layers, such as 520 and 530. The input data to each convolutional layer contains the concatenation of all output data of the previous convolutional layers, thereby forming the dense connectivity. For example, the input data to the layer 530 includes the data 512, which may be the initial input data or the output data from a prior convolutional layer, and the data 522, which is the input data from the layer 520.

In some embodiments, each convolutional layer comprises a bottleneck layer having one or more 1×1 2D kernels, such as the layer 504, to consolidate the input data comprising K feature maps due to the dense connectivity into a smaller number of feature maps. For example, each 1×1 2D kernel can be applied respectively to each group of K/2N feature maps, to effectively sum the K/2N feature maps into one feature map, and to ultimately obtain 2N feature maps. Alternatively, a total of 2N 1×1 2D kernel could be applied to all feature maps to generate 2D feature maps. Each 1×1 2D kernel could be followed by a nonlinear activation function, such as a PReLU, and/or a batch normalization layer.

In some embodiment, each convolutional layer comprises a small conv2d layer with N kernels, such as the block 506 having a 3×3 convd2d layer, following the bottleneck layer to produce N feature maps. These small conv2d layers in successive convolutional layers of the block 500 employ exponentially increasing dilations along the time axis to model larger and larger context information. For example, the dilation factor used in the block 506 is 1, meaning no dilation in each kernel, while the dilation factor used in the block 508 is 2, meaning that the kernel is dilated in the time axis by a factor of two and the receptive field also increases in size by a factor of two in each dimension.

In some embodiments, between the convolutional layers of the block 500, the server 102 linearly projects the band energies to a learned space in a frequency mapping layer for a more unified outputs, such as the one described in arXiv:1904.11148v1 [cs.SD] 25 Apr. 2019. As the same kernel might produce different effects on the same audio data depending on in which frequency band where the audio data is located, some unification of such effects across different bands would be helpful. For example, a frequency mapping layer 580 is located in the middle of depth of the block 500.

In some embodiments, at the end of the block 500, a layer 590 similar to the bottleneck layer having one more a 1×1 2D kernels can be used to produce a output a tensor with N feature maps.

### 4.1.1.1.1. Depth-Wise Separable Convolution with Gating

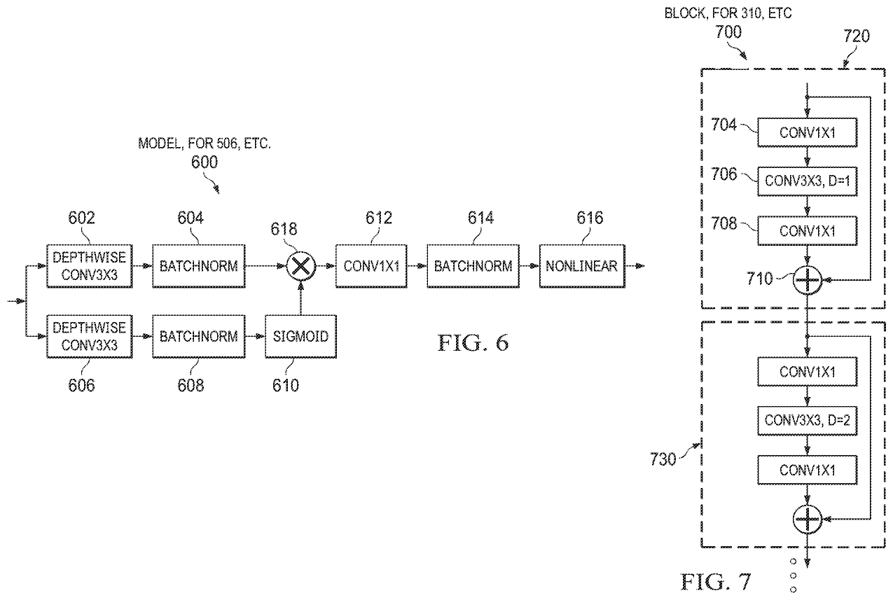

FIG. 6 illustrates an example neural network model, which corresponds an embodiment of the block 506 and every other similar block illustrated in FIG. 5. In some embodiments, block 600 comprises depth-wise separable convolution with a nonlinear activation function, such as gated linear unit (GLU). As illustrated in FIG. 6, the first pathway in the GLU comprises a depth-wise small conv2d layer, such as a 3×3 conv2d layer 602, which is followed by a batch normalization layer 604. The second pathway in the GLU similarly comprises a 3×3 conv2d layer 606, followed by a batch normalization layer 608, which is then followed by a learnable gating function, such as the sigmoid nonlinear activation function. Just as in a dense block illustrated in FIG. 5, the small conv2d layers in successive convolutional layers of the block 500 can employ exponentially increasing dilations along the time axis to model larger and larger context information. For example, the blocks 602 and 606 in the convolutional layer that corresponds to the block 506 can be associated with a dilation factor of 1, and similar blocks in the next convolutional layer that may correspond to an embodiment of the block 508 could be associated with a dilation factor of 2. The gating function identifies important regions of the input data for the task of interest. The two pathways are joined by the Hadamard product operator 618. The 1×1 conv2d layer 612 learns the inter-connections among the output feature maps generated by the combination of the two pathways, as part of the depth-wise separable convolution. The layer 612 can be followed by a batch normalization layer 614 and a nonlinear activation function 616, such as a PReLU.

### 4.1.2.2 Residual Block and Recurrent Layer

FIG. 7 illustrates an example neural network model, which corresponds to an embodiment of the block 310 and every other similar block illustrated in FIG. 3. In some embodiments, the block 500 illustrated in FIG. 5, which also corresponds to an embodiment of the block 310, could be replaced by a residual 700 block for a reduced number of connections. The block 700 comprises multiple convolutional layers, such as layers 720 and 730.

In some embodiments, each convolutional layer comprises a bottleneck layer similar to the block 504 illustrated in FIG. 5, such as the layer 704. The bottleneck layer could also be followed by a nonlinear activation, such as a PReLU, and/or a batch normalization layer.

In some embodiments, the convolutional layer also comprises a small conv2d layer, similar to the block 506 illustrated in FIG. 5, such as the 3×3 conv2d layer 706. The small conv2d block could be performed with dilation, with an exponentially increasing dilation factors over successive convolutional layers. The small conv2d layer can be replaced by depth-wise separable convolution with gating, as illustrated in FIG. 6.

In some embodiments, the convolutional layer comprises another 1×1 conv2d layer, such as the layer 708, that matches the output of the block 706 back to the input of block 704 in terms of size and specifically the number of channels or feature maps. The output is then added to the input data through the Hadamard product operator 710 to reduce gradient vanishing problem when using backpropagation to train the network, as the gradient will have a direct path from the output to the input side without any multiplication in between. The conv1×1 layer could also be followed by a nonlinear activation, such as a PReLU, and/or a batch normalization layer.

In some embodiments, the block 500 illustrated in FIG. 5, which also corresponds to an embodiment of the block 310, could be replaced by a recurrent layer comprising at least one recurrent neural network (RNN). Using an RNN to model long time sequences can be an efficient approach. “Efficient” means that the RNN could model very long time sequences by keeping an internal hidden state vector as a summary of all the history it has seen and generating the outputs for each new frame based on that vector. Compared with using dilation in CNN layers, the buffer size to store the past information for a RNN is much smaller (only 1 vector, vs 2d+1 vectors for a CNN where d is the dilation factor).

### 4.2. Model Training

In some embodiments, training of the neural network model 208 can be performed as an end-to-end process. Alternatively, the feature extraction block 308 and the U-Net block 340 can be trained separately, where output of applying the feature extraction block 308 to actual data can be used as training data for the U-Net block.

Diverse training data is used to train the neural network model 208 illustrated in FIG. 2. In some embodiments, the diversity incorporates speaker diversity, by including in the training data natural utterances in a wide range of speaking styles, in terms of speed, emotion, and other attributes. Each training utterance may be speech from one speaker or a dialogue among multiple speakers.

In some embodiments, the diversity comes from the inclusion of concentrated noise data, including reverberation data. A database like AudioSet can be used as a seed noise database. The server 102 can filter out each clip in the seed noise database with a class label that indicates likely presence of speech in the clip. For example, the class of “Human Voice” in the given ontology can be filtered out. The seed noise database can be further filtered by applying any speech separation technique known to someone skilled in the art to remove additional clips where speech is likely present. For example, any clip for which the speech prediction contains at least one frame (e.g., of length 100 ms) with root-mean-square energy above a threshold (e.g., 1e-3) is removed.

In some embodiments, the diversity is increased by including a wide range of intensity levels in mixing noise with speech. In composing a noisy signal, the server 102 can respectively scale a clean speech signal and a noise signal to predetermined loudest levels, randomly adjust each down by one of a range of dB, such as 0 to 30 dB, and randomly add up an adjusted clean speech signal and an adjusted noise signal, subject to a predetermined lowest signal-to-noise ratio. Such a wide range of loudness levels is found to help reduce over-suppression of speech (or under-suppression of noise).

In some embodiments, the diversity lies in the presence of data in different frequency bands. The server 102 can create signals having at least a certain percentage in a specific frequency band of a specific bandwidth, such as at least 20% in a frequency band from 300 Hz to 500 Hz.

In some embodiments, the server 102 trains the neural network model 208 using any optimization process known to someone skilled in the art, such as the stochastic gradient descent optimization algorithm where the weights are updated using the backpropagation of error algorithm. The neural network model 208 can minimize the mean squared error (MSE) loss between the predicted mask and the ground truth mask for each band at each frame. The ground truth mask can be computed as the ratio of the speech energy and the sum of the speech and noise energies.

In some embodiments, since over-suppression of speech hurts speech quality more than under-suppression of speech, the server 102 uses a weighted MSE that assigns more penalty to over-suppression of speech. As the mask value produced by the neural network model 208 indicates the amount of speech present, when a predicted mask value is less than the ground-truth mask value, less speech is being predicted than the ground truth and thus more speech is being suppressed than necessary, leading to over-suppression of speech by the neural network model. For example, the weighted MSE can be computed as follows:

$$loss = \{ \begin{matrix}{ρ [ \hat{m} ( t , f ) - m ( t , f ) ]}^{2} if \hat{m} ( t , f ) < m ( t , f ) \\ {( 1 - ρ ) [ \hat{m} ( t , f ) - m ( t , f ) ]}^{2} if if \hat{m} ( t , f ) > m ( t , f )\end{matrix}$$

where \hat{m}(t, f) and m(t, f) represent the predicted and ground-truth mask values for the (t, f) time-frequency band respectively, and ρ represents a constant empirically determined (usually set greater than 0.5) to give more weight to over-suppression of speech.

In some embodiments, the neural network model 208 is trained to predict the distribution of speech (rather than a single mask value) over different frequency bins within each band. Specifically, the server 102 can train the model to predict the mean and variance values of a Gaussian distribution for each band at each frame, where the mean represents the best prediction of the mask value by the neural network model 208. The loss function for the Gaussian distribution may be defined as:

$${loss}_{G} = log {\hat{s}}_{t , f} + 0 \text{.5} {( \frac{{m}_{t , f} - {\hat{m}}_{t , f}}{{\hat{s}}_{t , f}} )}^{2}$$

where ŝ(t, f) represents the prediction of the standard deviation for (t, f).

In some embodiments, the variance prediction can be interpreted as the confidence in the mean prediction to reduce the occurrence of over-suppression of speech. When the mean prediction is relatively low, indicating a low amount of speech present, and the variance prediction is relatively high, this could indicate likely over-suppression of speech and the band mask could then be scaled up. An example scaling function for producing an adjusted gain based on the standard deviation is:

g_{scale}=(1−e^{-ŝ}^{_{t,f}})(1−\hat{m}_{t,f})+\hat{m}_{t,f}

The scaling function increases the band mask (gain) in proportion to the standard deviation. When the standard deviation is large, the mask is scaled such that it is greater than the mean but still less than or equal to 1, and when the standard deviation is 0, the mask will be equal to the mean.

In some embodiments, assuming a Gaussian distribution for each mask, the probability of each observed (target) mask value is:

$$P ( {m}_{t , f} ) = \frac{1}{\sqrt{2 π}} \frac{1}{{\hat{S}}_{t , f}} exp \frac{{( {m}_{t , f} - {\hat{m}}_{t , f} )}^{2}}{2 {\hat{S}}_{t , f}^{2}}$$

Minimizing the negative logarithm of this probability (equivalent to maximizing the probability itself leads to the Gaussian loss function stated above.

### 4.3. Model Execution

In some embodiments, the server 102 can accept as input data individual frame, or a set of frames when lookahead is implemented in the neural network model 208, specifically the feature extraction block 308, and generate at least a mask value for each frame as output data. For each convolutional layer with a kernel size greater than one along the time dimension, the server 102 keeps an internal buffer to store the history it requires to generate the output data. The buffer can be maintained as a queue with a size equal to the receptive field of the convolutional layer along the time dimension.

### 5. Example Processes

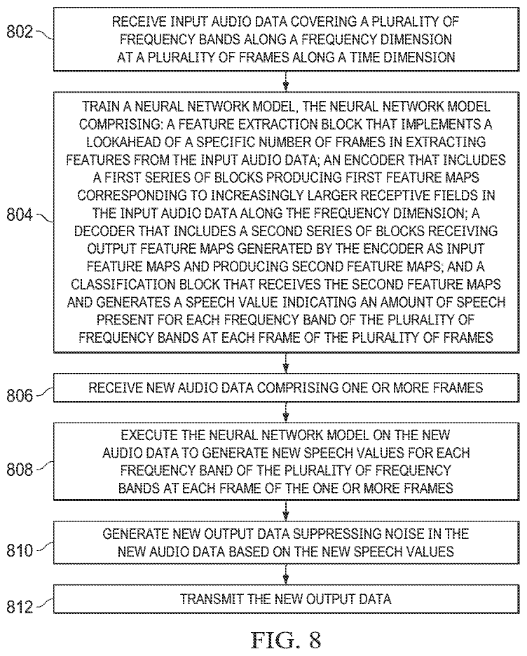

FIG. 8 illustrates an example process performed with an audio management server computer in accordance with some embodiments described herein. FIG. 8 is shown in simplified, schematic format for purposes of illustrating a clear example and other embodiments may include more, fewer, or different elements connected in various manners. FIG. 8 is each intended to disclose an algorithm, plan or outline that can be used to implement one or more computer programs or other software elements which when executed cause performing the functional improvements and technical advances that are described herein. Furthermore, the flow diagrams herein are described at the same level of detail that persons of ordinary skill in the art ordinarily use to communicate with one another about algorithms, plans, or specifications forming a basis of software programs that they plan to code or implement using their accumulated skill and knowledge.

In some embodiments, in step 802, the server 102 is programmed to receive input audio data covering a plurality of frequency bands along a frequency dimension at a plurality of frames along a time dimension. In some embodiments, the plurality of frequency bands are perceptually motivated bands, covering more frequency bins at higher frequencies.

In some embodiments, in step 804, the server 102 is programmed to train a neural network model. The neural network model comprises a feature extraction block that implements a lookahead of a specific number of frames in extracting features from the input audio data; an encoder that includes a first series of blocks producing feature maps corresponding to increasingly larger receptive fields in the input audio data along the frequency dimension; a decoder that includes a second series of blocks receiving output feature maps generated by the encoder as input feature maps; and a classification block that generates a speech value indicating an amount of speech present for each frequency band of the plurality of frequency bands at each frame of the plurality of frames.

In some embodiments, the feature extraction block has a convolution kernel that has a specific size along the time dimension, and the encoder and the decoder have no convolution kernel that has a size along the time dimension that is equal to or larger than the specific size. In other embodiments, each of the feature extraction block, the first series of blocks, and the second series of blocks produces a common number of feature maps.

In some embodiments, the feature extraction block comprises a batch normalization layer followed by a convolutional layer with a two-dimensional convolution kernel.

In some embodiments, each block of the first series of blocks in the encoder comprises a feature computation block and a frequency down-sampler. The feature computation block comprises a series of convolutional layers.

In some embodiments, output data of a convolutional layer of the series of convolutional layers are fed into all subsequent convolutional layers of the series of convolutional layers. The series of convolutional layers implements increasingly large dilation along the time dimension. In other embodiments, each of the series of convolutional layers comprises depth-wise separable convolutional blocks with a gating mechanism.

In some embodiments, each of the series of convolutional layers comprises a residual block having a series of convolutional blocks, including a first convolutional block having a first one-by-one two-dimensional convolution kernel and a last convolutional block having a last one-by-one two-dimensional convolution kernel.

In some embodiments, output data of a feature computation block in a block of the first series of blocks is scaled by a learnable weight to form scaled output data, and the scaled output data is communicated to a block of the second series of blocks in the decoder via a skip connection.

In some embodiments, a frequency down-sampler of a block in the first series of blocks comprises convolution kernels with a stride size greater than one along the frequency dimension.

In some embodiments, each block of the second series of blocks comprises a feature computation block and a frequency up-sampler. A feature computation block in a block of the second series of blocks receives first output data from a feature computation block in a block of the first series of blocks and second output data from a frequency up-sampler of a previous block in the second series of blocks. The first output data and the second output data are then concatenated or added to form specific input data for the feature computation block in the block of the second series of blocks.

In some embodiments, the classification block comprises a one-by-one two-dimensional convolution kernel and a nonlinear activation function.

In some embodiments, the neural network model further comprises a feature computation block being output data of the encoder and input data of the decoder.

In some embodiments, the server 102 is programmed to perform the training with a function of loss between a predicted speech value and a ground-truth speech value for each frequency band of the plurality of frequency bands at each frame, with a larger weight in the function of loss when the predicted speech value corresponds to over-suppression of speech and a smaller weight in the function of loss when the predicted speech value corresponds to under-suppression of speech. In some embodiments, the classification block further generates a distribution of speech amounts over a frequency band of the plurality of frequency bands at a frame, with the speech value being a mean of the distribution.

In some embodiments, the input audio data comprising data corresponding to speech of different speeds or emotions, data containing different levels of noise, or data corresponding to different frequency bins.

In some embodiments, in step 806, the server 102 is programmed to receive new audio data comprising one or more frames.

In some embodiments, in step 808, the server 102 is programmed to execute the neural network model on the new audio data to generate new speech values for each frequency band of the plurality of frequency bands at each frame of the one or more frames.

In some embodiments, in step 810, the server 102 is programmed to generate new output data suppressing noise in the new audio data based on the new speech values.

In some embodiments, in step 812, the server 102 is programmed to transmitting the new output data.

In some embodiments, the server 102 is programmed to receive an input waveform. The server 102 is programmed to then transform the input waveform into raw audio data covering a plurality of frequency bins along the frequency dimension at the one or more frames along the time dimension. The server 102 is programmed to then convert the raw audio data into the new audio data by grouping the plurality of frequency bins into the plurality of frequency bands. The server 102 is programmed to perform inverse banding on the new speech values to generate updated speech values for each frequency bin of the plurality of frequency bins at each frame of the one or more frames. In addition, the server 102 is programmed to then apply the updated speech values to the raw audio data to generate the new output data. Finally, the server 102 is programmed to transform the new output data into an enhanced waveform.

### 6. Hardware Implementation

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

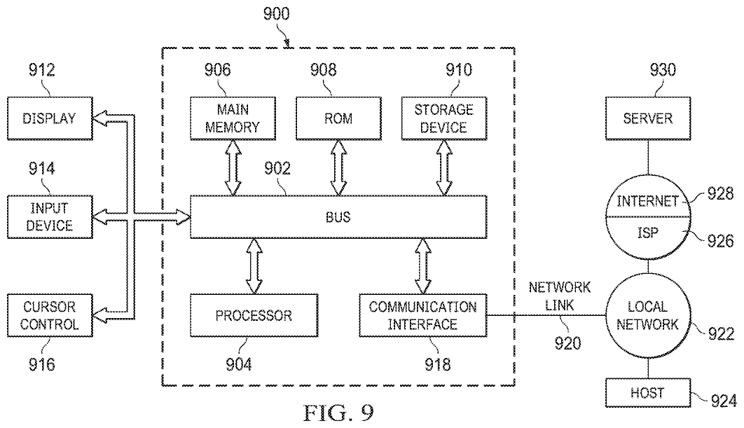

FIG. 9 is a block diagram that illustrates an example computer system with which an embodiment may be implemented. In the example of FIG. 9, a computer system 900 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 900 includes an input/output (I/O) subsystem 902 which may include a bus and/or other communication mechanism(s) for communicating information and/or instructions between the components of the computer system 900 over electronic signal paths. The I/O subsystem 902 may include an I/O controller, a memory controller and at least one I/O port. The electronic signal paths are represented schematically in the drawings, for example as lines, unidirectional arrows, or bidirectional arrows.

At least one hardware processor 904 is coupled to I/O subsystem 902 for processing information and instructions. Hardware processor 904 may include, for example, a general-purpose microprocessor or microcontroller and/or a special-purpose microprocessor such as an embedded system or a graphics processing unit (GPU) or a digital signal processor or ARM processor. Processor 904 may comprise an integrated arithmetic logic unit (ALU) or may be coupled to a separate ALU.

Computer system 900 includes one or more units of memory 906, such as a main memory, which is coupled to I/O subsystem 902 for electronically digitally storing data and instructions to be executed by processor 904. Memory 906 may include volatile memory such as various forms of random-access memory (RAM) or other dynamic storage device. Memory 906 also may be used for storing temporary variables or other intermediate information during execution of instructions to be executed by processor 904. Such instructions, when stored in non-transitory computer-readable storage media accessible to processor 904, can render computer system 900 into a special-purpose machine that is customized to perform the operations specified in the instructions.

Computer system 900 further includes non-volatile memory such as read only memory (ROM) 908 or other static storage device coupled to I/O subsystem 902 for storing information and instructions for processor 904. The ROM 908 may include various forms of programmable ROM (PROM) such as erasable PROM (EPROM) or electrically erasable PROM (EEPROM). A unit of persistent storage 910 may include various forms of non-volatile RAM (NVRAM), such as FLASH memory, or solid-state storage, magnetic disk or optical disk such as CD-ROM or DVD-ROM, and may be coupled to I/O subsystem 902 for storing information and instructions. Storage 910 is an example of a non-transitory computer-readable medium that may be used to store instructions and data which when executed by the processor 904 cause performing computer-implemented methods to execute the techniques herein.

The instructions in memory 906, ROM 908 or storage 910 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file processing instructions to interpret and render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or NoSQL, an object store, a graph database, a flat file system or other data storage.

Computer system 900 may be coupled via I/O subsystem 902 to at least one output device 912. In one embodiment, output device 912 is a digital computer display. Examples of a display that may be used in various embodiments include a touch screen display or a light-emitting diode (LED) display or a liquid crystal display (LCD) or an e-paper display. Computer system 900 may include other type(s) of output devices 912, alternatively or in addition to a display device. Examples of other output devices 912 include printers, ticket printers, plotters, projectors, sound cards or video cards, speakers, buzzers or piezoelectric devices or other audible devices, lamps or LED or LCD indicators, haptic devices, actuators or servos.

At least one input device 914 is coupled to I/O subsystem 902 for communicating signals, data, command selections or gestures to processor 904. Examples of input devices 914 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 916, which may perform cursor control or other automated control functions such as navigation in a graphical interface on a display screen, alternatively or in addition to input functions. Control device 916 may be a touchpad, a mouse, a trackball, or cursor direction keys for communicating direction information and command selections to processor 904 and for controlling cursor movement on display 912. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 914 may include a combination of multiple different input devices, such as a video camera and a depth sensor.

In another embodiment, computer system 900 may comprise an internet of things (IoT) device in which one or more of the output device 912, input device 914, and control device 916 are omitted. Or, in such an embodiment, the input device 914 may comprise one or more cameras, motion detectors, thermometers, microphones, seismic detectors, other sensors or detectors, measurement devices or encoders and the output device 912 may comprise a special-purpose display such as a single-line LED or LCD display, one or more indicators, a display panel, a meter, a valve, a solenoid, an actuator or a servo.

When computer system 900 is a mobile computing device, input device 914 may comprise a global positioning system (GPS) receiver coupled to a GPS module that is capable of triangulating to a plurality of GPS satellites, determining and generating geo-location or position data such as latitude-longitude values for a geophysical location of the computer system 900. Output device 912 may include hardware, software, firmware and interfaces for generating position reporting packets, notifications, pulse or heartbeat signals, or other recurring data transmissions that specify a position of the computer system 900, alone or in combination with other application-specific data, directed toward host 924 or server 930.

Computer system 900 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 900 in response to processor 904 executing at least one sequence of at least one instruction contained in main memory 906. Such instructions may be read into main memory 906 from another storage medium, such as storage 910. Execution of the sequences of instructions contained in main memory 906 causes processor 904 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 910. Volatile media includes dynamic memory, such as memory 906. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 902. Transmission media can also take the form of acoustic or light waves, such as those generated during radio-wave and infra-red data communications.

Various forms of media may be involved in carrying at least one sequence of at least one instruction to processor 904 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 900 can receive the data on the communication link and convert the data to be read by computer system 900. For instance, a receiver such as a radio frequency antenna or an infrared detector can receive the data carried in a wireless or optical signal and appropriate circuitry can provide the data to I/O subsystem 902 such as place the data on a bus. I/O subsystem 902 carries the data to memory 906, from which processor 904 retrieves and executes the instructions. The instructions received by memory 906 may optionally be stored on storage 910 either before or after execution by processor 904.

Computer system 900 also includes a communication interface 918 coupled to bus 902. Communication interface 918 provides a two-way data communication coupling to network link(s) 920 that are directly or indirectly connected to at least one communication networks, such as a network 922 or a public or private cloud on the Internet. For example, communication interface 918 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 922 broadly represents a local area network (LAN), wide-area network (WAN), campus network, internetwork or any combination thereof. Communication interface 918 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 918 sends and receives electrical, electromagnetic or optical signals over signal paths that carry digital data streams representing various types of information.

Network link 920 typically provides electrical, electromagnetic, or optical data communication directly or through at least one network to other data devices, using, for example, satellite, cellular, Wi-Fi, or BLUETOOTH technology. For example, network link 920 may provide a connection through a network 922 to a host computer 924.

Furthermore, network link 920 may provide a connection through network 922 or to other computing devices via internetworking devices and/or computers that are operated by an Internet Service Provider (ISP) 926. ISP 926 provides data communication services through a world-wide packet data communication network represented as internet 928. A server computer 930 may be coupled to internet 928. Server 930 broadly represents any computer, data center, virtual machine or virtual computing instance with or without a hypervisor, or computer executing a containerized program system such as DOCKER or KUBERNETES. Server 930 may represent an electronic digital service that is implemented using more than one computer or instance and that is accessed and used by transmitting web services requests, uniform resource locator (URL) strings with parameters in HTTP payloads, API calls, app services calls, or other service calls. Computer system 900 and server 930 may form elements of a distributed computing system that includes other computers, a processing cluster, server farm or other organization of computers that cooperate to perform tasks or execute applications or services. Server 930 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to interpret or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 930 may comprise a web application server that hosts a presentation layer, application layer and data storage layer such as a relational database system using structured query language (SQL) or NoSQL, an object store, a graph database, a flat file system or other data storage.

Computer system 900 can send messages and receive data and instructions, including program code, through the network(s), network link 920 and communication interface 918. In the Internet example, a server 930 might transmit a requested code for an application program through Internet 928, ISP 926, local network 922 and communication interface 918. The received code may be executed by processor 904 as it is received, and/or stored in storage 910, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 904. While each processor 904 or core of the processor executes a single task at a time, computer system 900 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

### 7. Extensions and Alternatives

In the foregoing specification, embodiments of the disclosure have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

1-21. (canceled)

22. A method of suppressing noise and enhancing speech, comprising:
receiving, by a processor, input audio data covering a plurality of frequency bands along a frequency dimension at a plurality of frames along a time dimension;
training, by the processor, a neural network model using the input audio data, the neural network model comprising:
a feature extraction block that implements a lookahead of a specific number of frames in extracting features from the input audio data;
an encoder that includes a first series of blocks producing first feature maps corresponding to increasingly larger receptive fields in the input audio data along the frequency dimension;
a decoder that includes a second series of blocks receiving output feature maps generated by the encoder as input feature maps and producing second feature maps;
wherein each block of the first series of blocks comprising a feature computation block and a frequency down-sampler, the feature computation block comprising a series of convolutional layers, and wherein output data of a convolutional layer of the series of convolutional layers being fed into all subsequent convolutional layers of the series of convolutional layers, the series of convolutional layers implementing increasingly large dilation along the time dimension; and
a classification block that receives the second feature maps and generates a speech value indicating an amount of speech present for each frequency band of the plurality of frequency bands at each frame of the plurality of frames;
receiving new audio data comprising one or more frames;
executing the neural network model on the new audio data to generate new speech values for each frequency band of the plurality of frequency bands at each frame of the one or more frames;
generating new output data suppressing noise in the new audio data based on the new speech values;
transmitting the new output data.

23. The method of claim 22, further comprising:
receiving an input waveform;
transforming the input waveform into raw audio data covering a plurality of frequency bins along the frequency dimension at the one or more frames along the time dimension;
converting the raw audio data into the new audio data by grouping the plurality of frequency bins into the plurality of frequency bands;
performing inverse banding on the new speech values to generate updated speech values for each frequency bin of the plurality of frequency bins at each frame of the one or more frames;
applying the updated speech values to the raw audio data to generate the new output data;
transforming the new output data into an enhanced waveform.

24. The method of claim 22, wherein the plurality of frequency bands comprise perceptually motivated bands, covering more frequency bins at higher frequencies.

25. The method of claim 22, wherein
the feature extraction block comprises a convolution kernel that has a specific size along the time dimension,
the specific size being larger than a size along the time dimension of any convolution kernel in the encoder or the decoder.

26. The method of claim 22, wherein the feature extraction block comprises a batch normalization layer followed by a convolutional layer with a two-dimensional convolution kernel.

27. The method of claim 22, wherein each of the feature extraction block, the first series of blocks, and the second series of blocks produce a common number of feature maps.

28. The method of claim 22, wherein each of the series of convolutional layers comprises depth-wise separable convolutional blocks with a gating mechanism.

29. The method of claim 22, wherein each of the series of convolutional layers comprises a residual block having a series of convolutional blocks, including a first convolutional block having a first one-by-one two-dimensional convolution kernel and a last convolutional block having a last one-by-one two-dimensional convolution kernel.

30. The method of claim 22, wherein
output data of a feature computation block in a block of the first series of blocks is scaled by a learnable weight to form scaled output data, and wherein
the scaled output data is communicated to a block of the second series of blocks in the decoder via a skip connection.

31. The method of claim 22, wherein a frequency down-sampler of a block in the first series of blocks comprises convolution kernels with a stride size greater than one along the frequency dimension.

32. The method of claim 22, wherein each block of the second series of blocks comprises a feature computation block and a frequency up-sampler.

33. The method of claim 32, further comprising:
a feature computation block in a block of the second series of blocks receiving first output data from a feature computation block in a block of the first series of blocks and second output data from a frequency up-sampler of a previous block in the second series of blocks,
the first output data and the second output data being concatenated or added to form specific input data for the feature computation block in the block of the second series of blocks.

34. The method of claim 22, wherein the classification block comprises a one-by-one two-dimensional convolution kernel and a nonlinear activation function.

35. The method of claim 22, wherein the training is performed with a function of loss between a predicted speech value and a ground-truth speech value for each frequency band of the plurality of frequency bands at each frame, with a larger weight in the function of loss when the predicted speech value corresponds to over-suppression of speech and a smaller weight in the function of loss when the predicted speech value corresponds to under-suppression of speech.

36. The method of claim 22, wherein the classification block further generates a distribution of speech amounts over a frequency band of the plurality of frequency bands at a frame, with the speech value being a mean of the distribution.

37. The method of claim 22, wherein the input audio data comprises data corresponding to speech of different speeds or emotions, data containing different levels of noise, or data corresponding to different frequency bins.

38. The method of claim 22, wherein the neural network model further comprises a feature computation block being output data of the encoder and input data of the decoder.

39. A system, comprising:
a memory;
one or more processors coupled with the memory and configured to perform:
receiving input audio data covering a plurality of frequency bands along a frequency dimension at a plurality of frames along a time dimension;
training a neural network model using the input audio data, the neural network model comprising:
a feature extraction block that implements a lookahead of a specific number of frames in extracting features from the input audio data;
an encoder that includes a first series of blocks producing first feature maps corresponding to increasingly larger receptive fields in the input audio data along the frequency dimension;
a decoder that includes a second series of blocks receiving output feature maps generated by the encoder as input feature maps and producing second feature maps;
wherein each block of the first series of blocks comprising a feature computation block and a frequency down-sampler, the feature computation block comprising a series of convolutional layers, and wherein output data of a convolutional layer of the series of convolutional layers being fed into all subsequent convolutional layers of the series of convolutional layers, the series of convolutional layers implementing increasingly large dilation along the time dimension; and
a classification block that receives the second feature maps and generates a speech value indicating an amount of speech present for each frequency band of the plurality of frequency bands at each frame of the plurality of frames;
storing the neural network model.

40. A method of suppressing noise and enhancing speech, comprising:
receiving, by a processor, new audio data comprising one or more frames;
executing, by the processor, a neural network model on the new audio data to generate new speech values for each frequency band of a plurality of frequency bands at each frame of the one or more frames,
the neural network model comprising computer-executable instructions for:
a feature extraction block that implements a lookahead of a specific number of frames in extracting features from input audio data;
an encoder that includes a first series of blocks producing first feature maps corresponding to increasingly larger receptive fields in the input audio data along the frequency dimension;
a computation block that connects the encoder and a decoder;
the decoder that includes a second series of blocks receiving output feature maps generated by the encoder as input feature maps and producing second feature maps;
wherein each block of the first series of blocks comprising a feature computation block and a frequency down-sampler, the feature computation block comprising a series of convolutional layers, and wherein output data of a convolutional layer of the series of convolutional layers being fed into all subsequent convolutional layers of the series of convolutional layers, the series of convolutional layers implementing increasingly large dilation along the time dimension; and
a classification block that receives the second feature maps and generates a speech value indicating an amount of speech present for each frequency band of the plurality of frequency bands at each frame of a plurality of frames; and
the neural network model being trained with the input audio data covering the plurality of frequency bands along a frequency dimension at the plurality of frames along a time dimension;
generating new output data suppressing noise in the new audio data based on the new speech values;
transmitting the new output data.
